(19) United States
(12) Patent Application Publication
(10) Pub. No.: US 2023/0359865 A1
(43) Pub. Date: Nov. 9, 2023

(54) Modeling Dependencies with Global Self-Attention Neural Networks

(71) Applicant: Google LLC, Mountain View, CA (US)

(72) Inventors: Zhuoran Shen, Newcastle, WA (US); Raviteja Vemulapalli, Seattle, WA (US); Irwan Bello, San Francisco, CA (US); Xuhui Jia, Seattle, WA (US); Ching-Hui Chen, Shoreline, WA (US)

(21) Appl. No.: 18/044,842

(22) PCT Filed: Sep. 16, 2020
(86) PCT No.: PCT/US2020/050995

§ 371 Date: Mar. 10, 2023

(51) Int. Cl. G06N 3/045; G06N 3/084

(52) U.S. Cl. CPC G06N 3/045; G06N 3/084

(57) ABSTRACT

The present disclosure provides systems, methods, and computer program products for modeling dependencies throughout a network using a global-self attention model with a content attention layer and a positional attention layer that operate in parallel. The model receives input data comprising content values and context positions. The content attention layer generates one or more output features for each context position based on a global attention operation applied to the content values independent of the context positions. The positional attention layer generates an attention map for each of the context positions based on one or more content values of the respective context position and associated neighboring positions. Output is determined based on the output features generated by the content attention layer and the attention map generated for each context position by the positional attention layer. The model improves efficiency and can be used throughout a deep network.

### FIELD

The present disclosure generally relates to machine learning architectures. More particularly, the present disclosure relates to systems, methods, and computer program products to perform modeling of dependencies using global self-attention neural networks.

### BACKGROUND

The modeling of interactions is important in machine learning. Attention has emerged as a common approach for capturing interactions and has become preferred over recurrence-based approaches. However, attention operations suffer from per-example quadratic memory and computational complexities due to the large memory footprint and computational requirements associated with materializing attention maps. In fact, the large memory requirements of self-attention have hindered the use of attention in long sequences and multidimensional inputs such as images, which generally include tens of thousands of pixels. Existing approaches generally restrict attention to later stages of a network or limit the receptive field of attention to local neighborhoods. In addition, existing approaches lack the efficiency required for use in backbone processing of deep neural networks.

### SUMMARY

Aspects and advantages of embodiments of the present disclosure will be set forth in part in the following description, or can be learned from the description, or can be learned through practice of the embodiments.

One example aspect of the present disclosure is directed to a system for modeling dependencies using global-self attention. The system includes one or more machine-learned models each configured to receive a model input and process the model input to generate a model output, where each of the machine-learned models comprises a content attention layer and a positional attention layer configured to operate in parallel with each other. In addition, each of the machine-learned models is configured to perform operations that include receiving a layer-input comprising input data that comprises a plurality of content values each associated with one or more context positions, generating, by a respective content attention layer, one or more output features for each context position based on a global attention operation applied to the content values independent of the context positions, generating, by a respective positional attention layer, an attention map for each of the context positions based on one or more of the content values associated with the respective context position and a neighborhood of context positions relative to the respective context position where the positional attention layer comprises at least a column-focused attention sublayer that attends to context positions along a column of each respective context position and a row-focused attention sublayer that attends to context positions along a row of each respective context position, and determining a layer-output based at least in part on the one or more output features for each context position generated by the content attention layer and the attention map generated for each context position by the positional attention layer.

Other aspects of the present disclosure are directed to various apparatuses, non-transitory computer-readable media, computer-implemented methods, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example self-attention model for performing the modeling of dependencies with global self-attention according to example embodiments of the present disclosure.

FIG. 2 depicts a flow diagram of an example method for performing the modeling of dependencies with global self-attention according to example embodiments of the present disclosure.

FIG. 3 depicts a block diagram of an example global self-attention network employing self-attention models according to example embodiments of the present disclosure.

FIG. 4 depicts example results comparing the performance of global self-attention networks with networks utilizing spatial convolutions according to example embodiments of the present disclosure.

FIG. 5 depicts example results comparing global self-attention networks with other various attention-based configurations according to example embodiments of the present disclosure.

FIG. 6 depicts example results comparing different variants of global self-attention networks according to example embodiments of the present disclosure.

FIG. 7 depicts example results of replacing convolutions with self-attention models at different stages of a global self-attention network according to example embodiments of the present disclosure.

FIG. 8 depicts example results comparing the use of differently sized neighborhoods with a positional attention layer according to example embodiments of the present disclosure.

FIG. 9 depicts example results comparing different axial configurations of self-attention models according to example embodiments of the present disclosure.

FIG. 10A depicts a block diagram of an example computing system that performs the modeling of dependencies with global self-attention according to example embodiments of the present disclosure.

FIG. 10B depicts a block diagram of an example computing device that performs the modeling of dependencies with global self-attention according to example embodiments of the present disclosure.

FIG. 10C depicts a block diagram of an example computing device that performs the modeling of dependencies with global self-attention according to example embodiments of the present disclosure.

Reference numerals that are repeated across different figures are intended to identify the same features in various implementations.

### DETAILED DESCRIPTION

### Overview

Generally, the present disclosure is directed to modeling dependencies with global self-attention neural networks. Examples described in the present disclosure enable the modeling of various types of dependencies (e.g., long-range dependencies, medium-range dependencies, short-range dependencies, and/or any other types of dependencies), using fully global attention operations in self-attention networks, for example, without assistance from convolutional layers. Such example implementations provide improvements over existing approaches and can be implemented to provide global attention operations throughout a neural network. In particular, examples of the present disclosure provide improved performance and reduced computational requirements as compared to existing approaches.

While attention has become a preferred way of capturing interactions, attention operations suffer from per-example quadratic memory complexity due to attention maps. For example, applying a single multi-head attention layer on a batch of 256 sequences of length 2048 with 8 heads requires 8 GB of memory, which is prohibitive in practice. Further, the large memory requirements of self-attention have hindered the use of attention operations in long sequences and multidimensional inputs such as images, which generally include tens of thousands of pixels. As such, existing approaches generally restrict attention to later stages of a network or restrict the receptive field of attention to local neighborhoods.

To resolve these issues, the present disclosure provides examples of a global self-attention model as an alternative to conventional approaches. In examples of the present disclosure, the global self-attention model is configured with a content attention layer and a positional attention layer that operate in parallel with each other. For example, the content attention layer attends to an entire piece of content at once (e.g., an image) without taking spatial position (e.g., pixels) of the content into account. The positional attention layer operates on spatial positions of the content. For example, the positional attention layer operates on each spatial position based on the content associated with a respective spatial position and a neighborhood of spatial positions relative to the respective spatial position. The positional attention layer may include a column-only attention sublayer that attends to spatial positions along a column of spatial positions in the neighborhood of positions relative to a respective spatial position and a row-only attention sublayer that attends to spatial positions along a row of spatial positions in the neighborhood of positions relative to the respective spatial position. The example implementations described in the present disclosure provide performance improvements and reduced computational requirements compared to existing approaches and enable the modeling of long-range dependencies with global self-attention for various types of content (e.g., high-resolution images, videos, long sequences, 3D sensor data, and other very large inputs) throughout an entire neural network. Example experimental results described in the present disclosure show that the described example implementations outperform convolutional and attentional counterparts in accuracy and efficiency.

The systems, methods, and computer program products described herein provide a number of technical effects and benefits. As one example, the self-attention models described in the present disclosure perform modeling of long-range and/or other various types of dependencies more rapidly, with greater accuracy, using fewer parameters and with fewer computing resources (e.g., less processing power, less memory usage, less power consumption, etc.), as compared to, for example, conventional attention and convolutional operations.

The systems, methods and computer program products are particularly well suited to computer vision and in particular, to analyzing video data, as global-self attention allows for improved modeling of long-range dependencies. Nevertheless, the methodology described herein can be applied to a variety of technical applications, including image recognition, image classification, image captioning, scene segmentation, object detection, action recognition, action localization, image synthesis, semantic segmentation, panoptic segmentation, or natural language processing. Additional applications include analysis of audio data, such as processing speech data to generate one or more of a speech recognition output, a speech translation output, a latent embedding output, an encoded speech output, an upscaled speech output, a textual representation output or a prediction output. Further applications include encoding data (e.g. for compression, such as compressing audio data or visual data), or encrypting or decrypting data. The input data may include, among other things, audio data, visual data (e.g. image or video data) or sensor data.

With reference now to the Figures, example embodiments of the present disclosure will be discussed in further detail.

### Example Global Self-Attention Model

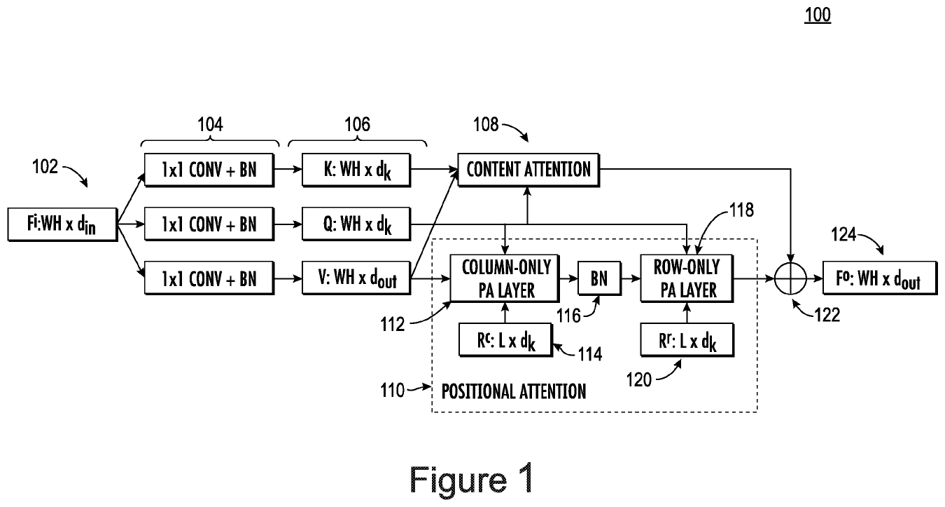

FIG. 1 depicts a block diagram of an example self-attention model 100 for performing the modeling of dependencies with global self-attention according to example embodiments of the present disclosure.

FIG. 1 includes input data 102 (Fⁱ∈ [symbol] ^{WH×d}^{ᵢₙ}), 1×1 convolution and batch normalization layers 104, keys, queries, and values 106, a content attention layer 108, a positional attention layer 110, a column-only attention sublayer 112, learnable relative position embeddings along a column 114, a batch normalization sublayer 116, a row-only attention sublayer 118, learnable relative position embeddings along a row 120, output data generation 122, and output data 124 (F^{o}∈ [symbol] ^{WH×d}^{ₒᵤₜ}).

In some examples, input data 102 (Fⁱ ∈ [symbol] ^{WH×d}^{ᵢₙ}) and output data 124 (F^{o}∈ [symbol] ^{WH×d}^{ₒᵤₜ}) represent spatially flattened input and output feature maps of self-attention model 100 where W and H represent width and height spatial dimensions, and dᵢₙ and dₒᵤₜ represent channel dimensions. In addition, each spatial position (e.g., pixel) in an output feature map of output data 124 (F^{o}∈ [symbol] ^{WH×d}^{ₒᵤₜ}) may be generated by aggregating information from every spatial position in an input feature map of input data 102 (Fⁱ∈ [symbol] ^{WH×d}^{ᵢₙ}) based on content and spatial positions.

In some examples, three 1×1 convolution and batch normalization layers 104 are used to generate matrices of keys, queries, and values 106 as intermediate output. For example, three 1×1 convolutions may be used to process an input feature map Fⁱ input data 102 followed by batch normalization to produce keys (K=[kᵢⱼ]∈ [symbol] ^{WH×d}^{ₖ}) queries (Q=[qᵢⱼ]∈ [symbol] ^{WH×d}^{ₖ}), and values (V=[vᵢⱼ]∈ [symbol] ^{WH×d}^{ₒᵤₜ}). In various examples, dₖ denotes a number of channels used for keys and queries and each row in the matrices corresponds to an input value. In an example, keys generally may refer to spatial positions (i.e., context positions) associated with content, queries generally may refer to portions of the content, and values generally may refer to values associated with or representing the actual content itself.

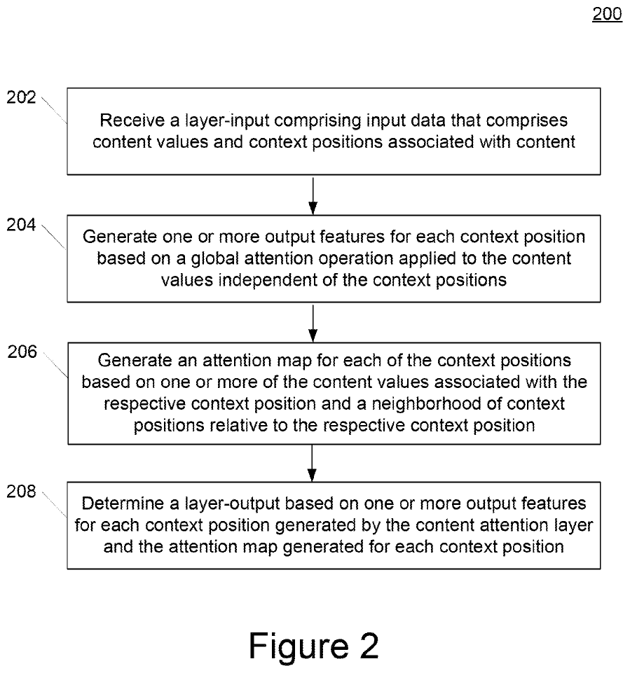

In some examples, content attention layer 108 receives matrices of keys, queries, and values 106 as input and generates output features for each content element in a piece of content using a global attention operation without taking spatial arrangement of the content elements into account. As such, content attention layer 108 uses a global content attention operation that attends to a piece of content at once rather than by row, by column, or piece by piece. Further examples and details describing processing performed by content attention layer 108 are described in FIG. 2.

Positional attention layer 110 includes column-only attention sublayer 112 and row-only attention sublayer 118, which in some examples are configured to operate in parallel with each other. In some examples, positional attention layer 110 generates an attention map for each context position in a piece of content based on one or more content values associated with a respective context position and based on a neighborhood size L of L×L spatial neighbors relative to the respective context position. As such, computational and memory complexities of positional attention layer 110 generally may be linear to a number of context positions and neighborhood size L. In some examples, the neighborhood size L used by positional attention layer 110 is configured to be a maximum value such that the positional attention layer 110 attends to an entire piece of content (e.g., a whole image).

In some examples, column-only attention sublayer 112 may be a column-focused attention sublayer that attends to context positions along a column of each respective context position in the neighborhood of context positions relative to a respective context position. Row-only attention sublayer 118 may be a row-focused attention sublayer that attends to context positions along a row of relative context positions. In some examples, column-only attention sublayer 112 and row-only attention sublayer 118 use relative position embeddings, respectively R^{c} and R^{r}, as keys. For example, column-only attention sublayer 112 may use learnable relative position embeddings along a column 114 while row-only attention sublayer 118 may use learnable relative position embeddings along a row 120.

In some examples, column-only attention sublayer 112 is followed by row-only attention sublayer 118. In some examples, column-only attention sublayer 112 may be followed by batch normalization sublayer 116, followed by row-only attention sublayer 118. Further examples and details describing processing performed by positional attention layer 110, column-only attention sublayer 112, and row-only attention sublayer 118 are described in FIG. 2.

In some examples, content attention layer 108 output and positional attention layer 110 output are used in output data generation 122 to produce output data 124. For example, outputs of content attention layer 108 and positional attention layer 110 may be summed as part of generating layer output data 124 for self-attention model 100.

### Example Methods

FIG. 2 depicts a flow diagram of an example method 200 for performing the modeling of dependencies with global self-attention according to example embodiments of the present disclosure. Although FIG. 2 depicts steps performed in a particular order for purposes of illustration and discussion as an example, the methods of the present disclosure are not limited to the particularly illustrated order or arrangement. The various steps of the method 200 can be omitted, rearranged, combined, and/or adapted in various ways without deviating from the scope of the present disclosure.

At 202, a computing system receives a layer-input comprising input data that comprises content values and context positions associated with content. In an example, self-attention model 100 of a computer system receives input data 102 relating to content. Input data 102 may include image data, video data, sensor data, audio data, textual data, or generally any other type of data in any format, size, or dimension (e.g., 2D, 3D, etc.). Input data 102 may be processed to generate one or more sets of keys, queries, and values 106 in association with modeling dependencies using global self-attention. For example, input data 102 may be processed using 1×1 convolution and batch normalization layers 104 to generate matrices of keys, queries, and values 106 as intermediate output for processing by content attention layer 108 and positional attention layer 110.

At 204, the computing system generates one or more output features for each context position based on a global attention operation applied to the content values independent of the context positions. In various examples, content attention layer 108 uses keys, queries, and values 106 to generate output features for each context position based on a single, fully global attention operation. For example, content attention layer 108 may generate new features F^{c}=[fᵢⱼ^{c}]∈ [symbol] ^{WH×d}^{ₒᵤₜ} based on a global attention operation F^{c}=Q*ρ(K^{T})*V where * refers to matrix multiplication, K^{T} refers to the matrix transpose of K, and ρ refers to the application of softmax normalization to each row separately. As such, softmax normalization is not applied to queries.

The global attention computation may be performed in two ways: F^{c}=(Q*ρ(K^{T}))*V or F^{c}=Q*(ρ(K^{T})*V). In various examples, content attention layer 108 computes the global attention operation based on F^{c}=Q*(ρ(K^{T})*V), which carries linear computational and memory complexities. In contrast, F^{c}=(Q*ρ(K^{T}))*V would require quadratic computational and memory complexities based on a number of context elements.

In some examples, the global attention operation F^{c}=Q*(ρ(K^{T})*V) may follow an interpretation where each row in the matrix ρ(K^{T}) represents an attention map over an entire piece of content (e.g., an image). Multiplication of Q with ρ(K^{T}) then results in a WH×WH attention matrix where each row corresponds to an attention map of one context element (e.g., pixel). In addition, when WH attention maps are multiplied with V, the values over the entire piece of content are aggregated to generate output features fᵢⱼ^{c} at each of the WH pixels.

In some examples, the global attention operation F^{c}=Q*(ρ(K^{T})*V) may follow another interpretation where the rows of matrix ρ(K^{T}) represent the weights for gathering local features into global context vectors, and the rows of Q represent the weights for redistributing the global context vectors back to individual context elements (e.g., pixels). The multiplication of ρ(K^{T}) with V results in dₖ global context vectors, and the multiplication of Q with these global context vectors generates the output features fᵢⱼ^{c} at each pixel.

In various examples, content attention layer 108 produces content attention layer 108 output based on the output features generated for each context position according to the global attention operation applied to the content values independent of the context positions. Content attention layer 108 output, for example, may be summed or otherwise combined with positional attention layer 110 output to generate layer output for self-attention model 100.

At 206, the computing system generates an attention map for each of the context positions based on one or more of the content values associated with the respective context position and a neighborhood of context positions relative to the respective context position.

In various examples, positional attention layer 110 computes an attention map for each context element (e.g., pixel) based on content of the respective context element and relative spatial positions of neighbors in an L×L neighborhood of the respective context element. In some examples, positional attention layer 110 does not take the content values of neighboring pixels into account while attending to the neighboring pixels.

In some examples, column-only attention sublayer 112 of positional attention layer 110 attends to context positions along a column, and row-only attention sublayer 118 of positional attention layer 110 attends to context positions along a row. Such axial processing may be used to propagate over an entire L×L neighborhood.

In some examples, column-only attention sublayer 112 and row-only attention sublayer 118 use relative position embeddings respectively, R^{c} and R^{r}, as keys. For example, column-only attention sublayer 112 may use learnable relative position embeddings along a column 114 while row-only attention sublayer 118 may use learnable relative position embeddings along a row 120.

In an example,

$$Δ = \{ - \frac{L - 1}{2} , … , 0 , … , \frac{L - 1}{2} \}$$

represents a set of L offsets, and R^{c}=[r_{δ}^{c}]∈ [symbol] ^{L×d}^{ₖ} refers to a matrix of L learnable relative position embeddings corresponding to L spatial offsets δ∈Δ along a column, and V_{ab}^{c}=[v_{a+δ,b}]∈ [symbol] ^{L×d}^{ₒᵤₜ} is a matrix consisting of values at the L column neighbors of a context element (e.g., at pixel (a, b)). If f_{ab}^{c} denotes the output of a column-only attention layer sublayer at the context element (e.g., pixel (a, b)), then a column-only positional attention mechanism that uses relative position embeddings R^{c} as keys, can be described as f_{ab}^{c}=ρ(q_{ab}*R^{cT})*V_{ab}^{c} where q_{ab} is a query at the context element (e.g., pixel (a, b)). The computational and memory complexities of column-only attention sublayer 112 are linear based on a number of context elements and a neighborhood size L. Similarly, a row-only attention sublayer 118 with linear computational and memory complexities can be defined using L learnable relative position embeddings R^{r}=[r_{δ}^{r}]∈ [symbol] ^{L×d}^{ₖ} corresponding to the L row neighbors.

In some examples, positional attention layer 110 includes one or more sublayers in addition to column-only attention sublayer 112 and row-only attention sublayer 118. For example, positional attention layer 110 also may include a time-based attention sublayer, depth-based attention sublayer, or other type of attention sublayer. In an example, additional sublayers of positional attention layer 110 may be processed in parallel with column-only attention sublayer 112 and/or row-only attention sublayer 118.

In some examples, positional attention layer 110 comprises column-only attention sublayer 112 followed by batch normalization sublayer 116, followed by row-only attention sublayer 118, followed by a second batch normalization sublayer (not shown), followed by a time or depth attention sublayer (also not shown). In an example, a time, depth, or other attention sublayer may use relative position embeddings along a plane.

In various examples, positional attention layer 110 output may be determined or otherwise generated, for example, based on summing or combining outputs resulting from processing performed by each sublayer of positional attention layer 110, such as column-only attention sublayer 112, row-only attention sublayer 118, and any additional attention sublayers (e.g., time or depth attention sublayer).

At 208, the computing system determines a layer-output based on one or more output features for each context position generated by the content attention layer and the attention map generated for each context position. In various examples, a layer-output is determined based on layer output generated from each of content attention layer 108 and positional attention layer 110. For example, such outputs may be summed or otherwise combined as part of output data generation 122 to generate layer output data 124 for self-attention model 100. In some examples, layer output data 124 may be used as layer input for a second or separate instance of self-attention model 100. For example, one or more self-attention models 100 may be used consecutively or non-consecutively as part of backbone processing throughout a deep neural network.

### Examples of Self-Attention Models in a Network

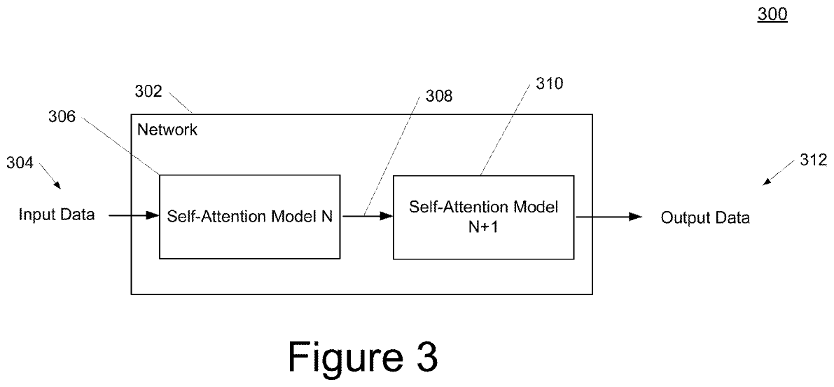

FIG. 3 depicts a block diagram of an example global self-attention network 300 employing self-attention models according to example embodiments of the present disclosure.

Global self-attention network 300 includes network 302, input data 304, self-attention model N 306, model output 308, self-attention model N+1 310, and output data 312. Global self-attention network 300 generally may refer to any network that utilizes one or more self-attention models 100 as part of backbone processing to perform the modeling of dependencies using self-attention throughout an entire network 302. In various examples, global self-attention network 300 may be used to model long-range dependencies, medium-range dependencies, short-range dependencies, and/or any other type(s) of dependencies, for example, without assistance from convolutional layers. Backbone processing of a network 302 generally may be described, for example, as processing that is primary to a network 302 and not considered auxiliary processing. In some examples, a network 302 may consist partially, mainly, or entirely of self-attention models 100.

Network 302 generally may represent any type of neural network which may be configured to use one or more self-attention models 100. In some examples, self-attention models 100 are used to replace spatial convolutions in a convolutional neural network to allow modeling of interactions throughout an entire network 302. For example, self-attention models 100 may be used to replace one, multiple, or all of the convolutions in a convolutional neural network.

In some examples, network 302 receives input data 304 associated with content. For example, self-attention model N 306 processes input data 304 as originally received or otherwise prepared and produces model output 308. In some examples, model output 308 from self-attention model N 306 is used as input for another self-attention model N+1 310, which for example, may generate output data 312 for network 302.

In general, network 302 may include any number of consecutive and/or non-consecutive instances of self-attention models (e.g., self-attention model N 306, self-attention model N+1 310, etc.). In an example, every non-input and non-output layer of network 302 may be separate instances of self-attention models (e.g., self-attention model N 306, self-attention model N+1 310, etc.). Also, instances of self-attention models within a network 302 generally may be referred to as self-attention modules or global self-attention modules.

### Example Experimental Results

Example experimental results are provided below for performing the modeling of dependencies with global self-attention according to example embodiments of the present disclosure. The present disclosure and its example embodiments are not limited to the example experiments described below.

As an overview, the experimental results show that “GSA-ResNet-50”, an example global self-attention (GSA) network created from ResNet-50 by replacing all 3×3 convolutions with GSA modules (e.g., self-attention model 100), improves the top-1 accuracy on the ImageNet validation dataset by 1.6% while using a fewer number of parameters and FLOPs as compared to convolution-based ResNet-50. GSA-ResNet-50 also outperforms various existing attention-based methods based on the ImageNet validation dataset.

In some experiments, an example GSA-ResNet-50 network was created by replacing all 3×3 convolution layers in ResNet-50 with self-attention model 100. After the first 7×7 convolution layer, GSA-ResNet-50 relied on the proposed global attention mechanism for modeling pixel interactions. An input size of 224×224 was used, and 2×2 average pooling layers (with stride 2) were used immediately after the first GSA module in the second, third and fourth residual groups to reduce spatial dimensions. The number of channels for keys, queries, and values in each GSA module was set to be the same as the corresponding input features. A multi-head attention mechanism with 8 heads was used in each GSA module. Relative position embeddings were shared across all heads within a module, but not across modules for purposes of the experiments. The neighborhood size L for positional attention was set to a maximum value such that the positional attention layer attends to the full image.

In some example experiments, models were trained from scratch for 90 epochs on the ImageNet training set using Stochastic Gradient Descent (SGD) with momentum of 0.9, cosine learning rate schedule with base learning rate of 0.1, label smoothing regularization with coefficient 0.1, weight decay of 10⁻⁴, and mini-batch size of 2048 (synchronous SGD on 32 TPU cores). Standard data augmentations such as random cropping and horizontal flipping were used. For evaluation, a single 224×224 center crop was utilized.

Additional experimental results obtained based on the CIFAR-100 data set and ResNet-50 were consistent with ImageNet results. For example, GSA-ResNet-50 outperformed the convolution-based ResNet-50 (83.9% vs 81.2%) while reducing the number of parameters (18.1 M vs 25.6 M) and FLOPs (7.2 G vs 8.2 G).

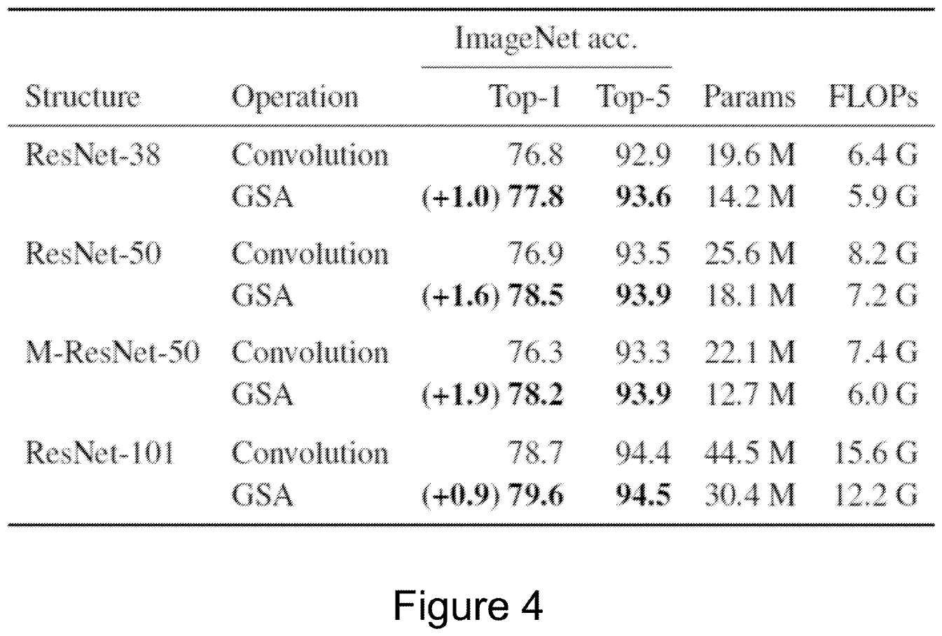

FIG. 4 depicts example results comparing the performance of global self-attention networks with networks utilizing spatial convolutions according to example embodiments of the present disclosure. The example results in FIG. 4 compare various types of global self-attention (GSA) networks to corresponding spatial, convolution-based networks based on the ImageNet validation dataset. The example results show that GSA networks provide greater accuracy over corresponding convolution-based networks while using fewer parameters and FLOPs.

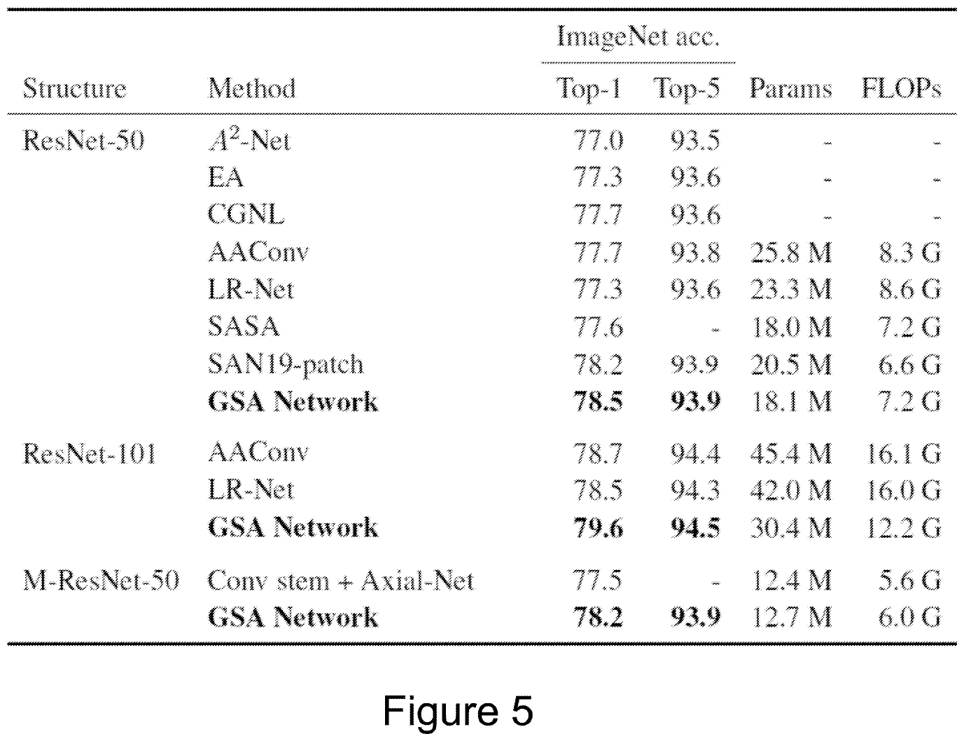

FIG. 5 depicts example results comparing global self-attention networks with other various attention-based configurations according to example embodiments of the present disclosure. The example results in FIG. 5 compare global self-attention (GSA) networks to other attention-based approaches based on the ImageNet validation dataset and show that GSA networks provide greater accuracy than conventional methods while using either a similar number of or fewer parameters and FLOPs.

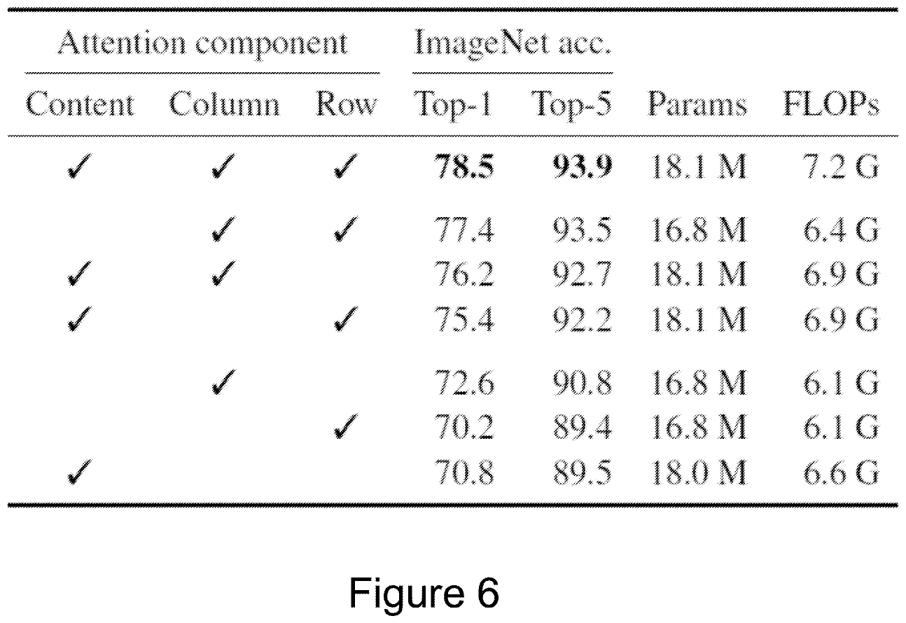

FIG. 6 depicts example results comparing different variants of global self-attention networks according to example embodiments of the present disclosure. The example results in FIG. 6 compare example variations of a global self-attention (GSA) model based on the use of different combinations of a content attention layer (e.g., content attention layer 108), and sublayers of a positional attention layer (e.g., column-only attention sublayer 112 and row-only attention sublayer 118 of positional attention layer 110). The example results show that a GSA module with a content attention layer and positional attention layer with column-only and row-only sublayers provides the best overall performance.

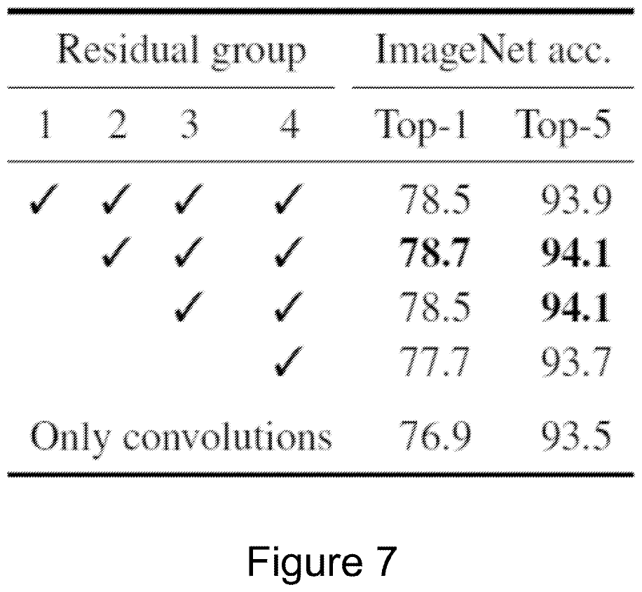

FIG. 7 depicts example results of replacing convolutions with global self-attention modules at different stages of a global self-attention network according to example embodiments of the present disclosure. In various examples, self-attention models 100 may be used to replace one, multiple, or even all of the convolutions in a network. The example results in FIG. 7 show how performance varies when global attention replaces spatial convolution in certain residual groups. Starting from the last residual group, moving towards earlier stages of a network, replacing convolution with attention improves performance consistently until the second residual group. Replacing convolutions in the first residual group results in a slight drop in the performance.

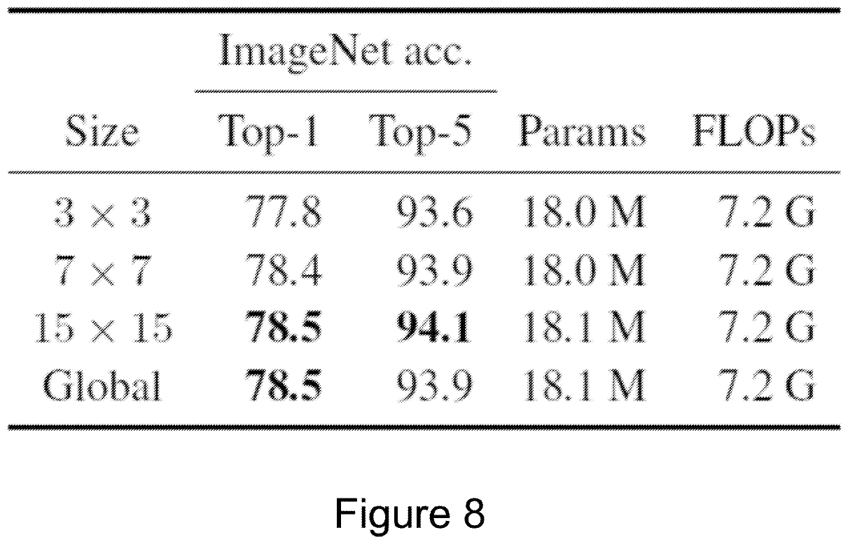

FIG. 8 depicts example results comparing the use of differently sized neighborhoods with a positional attention layer according to example embodiments of the present disclosure. The example results of FIG. 8 show how the performance varies with the neighborhood size L used by a positional attention layer (e.g., positional attention layer 110). The example results show that a 15×15 neighborhood provides the best performance, and performance generally does not vary significantly beyond a 7×7 neighborhood.

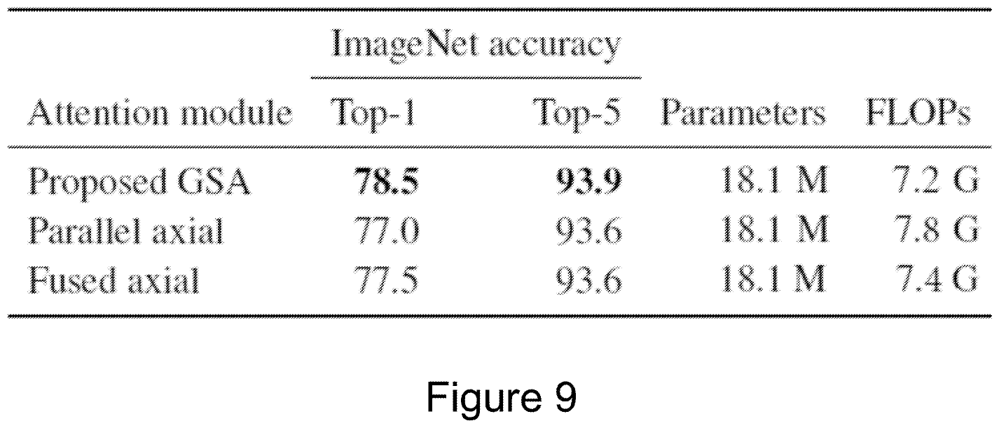

FIG. 9 depicts example results comparing different axial configurations of global self-attention modules according to example embodiments of the present disclosure. FIG. 9 compares example variations of a global self-attention (GSA) module based on different configurations of a content attention layer (e.g., content attention layer 108). The example results show that using fully global attention in a content attention layer based on a global attention operation applied to the content values independent of the context positions, as described in the present disclosure, provides better performance than use of fused or parallel axial operations that are based on interactions with context positions of content. (e.g., pixels of an image).

### Example Devices and Systems

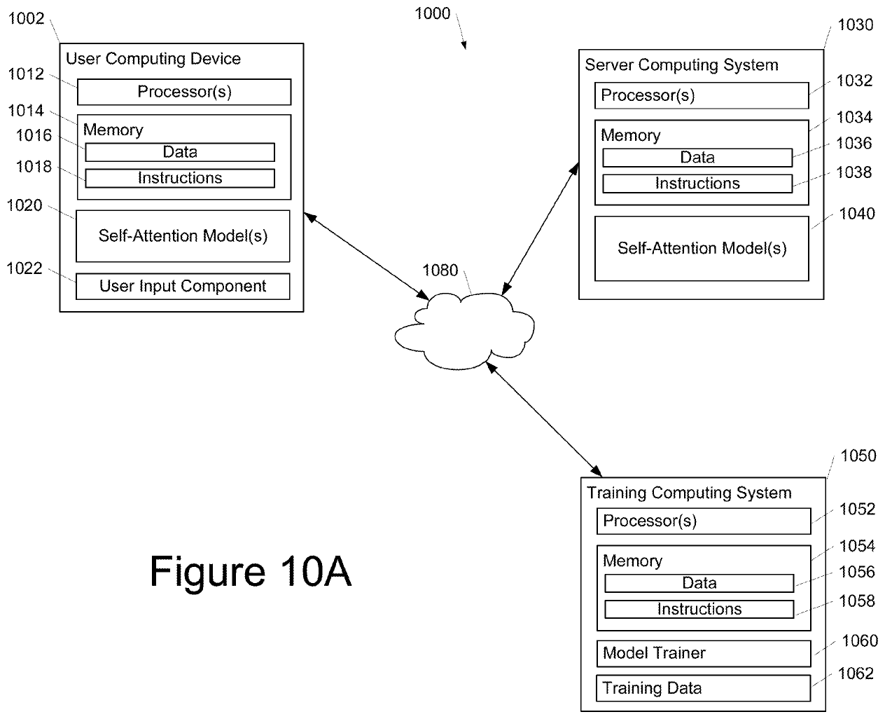

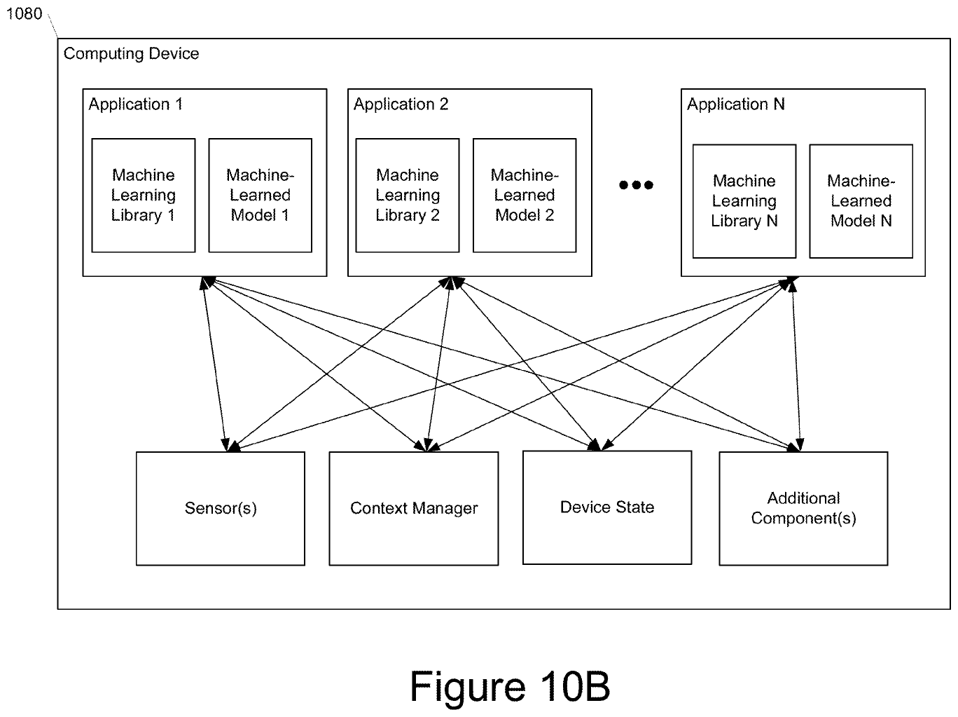

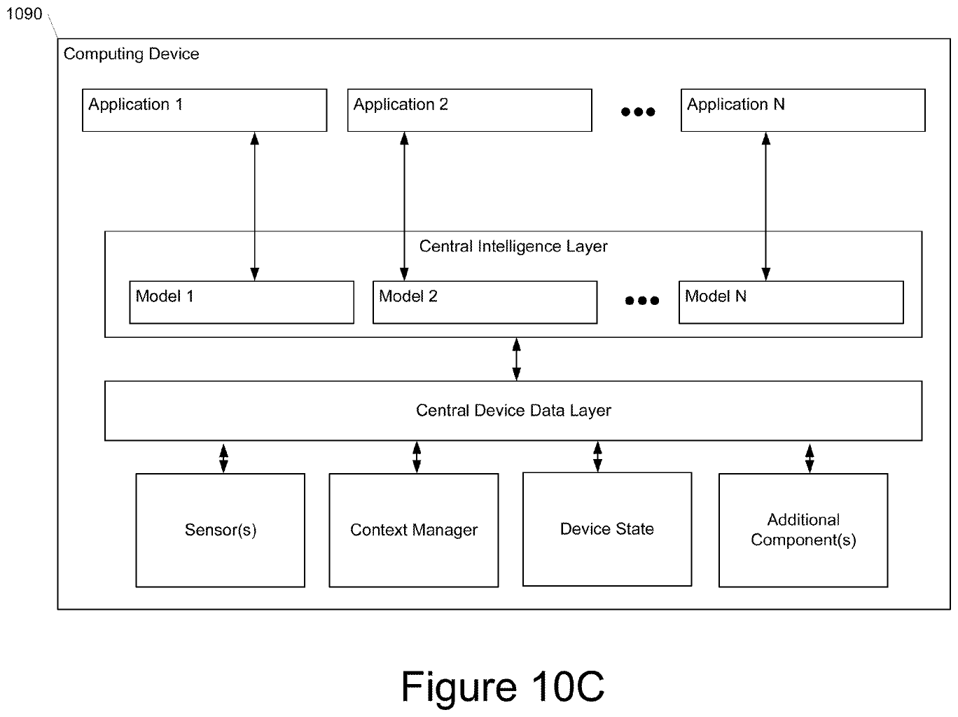

FIG. 10A depicts a block diagram of an example computing system 1000 that performs the modeling of dependencies with global self-attention according to example embodiments of the present disclosure. The system 1000 includes a user computing device 1002, a server computing system 1030, and a training computing system 1050 that are communicatively coupled over a network 1080.

The user computing device 1002 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 and instructions 1018 which are executed by the processor 1012 to cause the user computing device 1002 to perform operations.

In some implementations, the user computing device 1002 can store or include one or more self-attention models 1020 for performing the modeling of dependencies with global self-attention. For example, the self-attention models 1020 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example self-attention models 100 are discussed, for example, with reference to FIGS. 1-3.

In some implementations, the one or more self-attention models 1020 can be received from the server computing system 1030 over network 1080, stored in the user computing device memory 1014, and then used or otherwise implemented by the one or more processors 1012. In some implementations, the user computing device 1002 can implement multiple parallel instances of a single self-attention model 1020 (e.g., to perform parallel global self-attention across multiple instances of self-attention models 1020).

Additionally or alternatively, one or more self-attention models 1040 can be included in or otherwise stored and implemented by the server computing system 1030 that communicates with the user computing device 1002 according to a client-server relationship. For example, the self-attention models 1040 can be implemented by the server computing system 1040 as a portion of a web service (e.g., a service that utilizes and/or provides the modeling of dependencies with global self-attention neural networks). Thus, one or more models 1020 can be stored and implemented at the user computing device 1002 and/or one or more models 1040 can be stored and implemented at the server computing system 1030.

The user computing device 1002 can also include one or more user input component 1022 that receives user input. For example, the user input component 1022 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations.

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more machine-learned self-attention models 1040. For example, such models 1040 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 1040 are discussed, for example, with reference to FIGS. 1-3.

The user computing device 1002 and/or the server computing system 1030 can train the models 1020 and/or 1040 via interaction with the training computing system 1050 that is communicatively coupled over the network 1080. The training computing system 1050 can be separate from the server computing system 1030 or can be a portion of the server computing system 1030.

The training computing system 1050 includes one or more processors 1052 and a memory 1054. The one or more processors 1052 can be any suitable processing device (e.g., a processor core, a microprocessor, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the training computing system 1050 to perform operations. In some implementations, the training computing system 1050 includes or is otherwise implemented by one or more server computing devices.

The training computing system 1050 can include a model trainer 1060 that trains the machine-learned models 1020 and/or 1040 stored at the user computing device 1002 and/or the server computing system 1030 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 1060 can perform a number of generalization techniques (e.g., weight decays, dropouts, etc.) to improve the generalization capability of the models being trained.

In particular, the model trainer 1060 can train the self-attention models 1020 and/or 1040 based on a set of training data 1062. The training data 1062 can include, for example, image data, video data, sensor data, audio data, textual data, or generally any other type of data in any format or of various size and/or dimensions.

In some implementations, if the user has provided consent, the training examples can be provided by the user computing device 1002. Thus, in such implementations, the model 1020 provided to the user computing device 1002 can be trained by the training computing system 1050 on user-specific data received from the user computing device 1002. In some instances, this process can be referred to as personalizing the model.

The model trainer 1060 includes computer logic utilized to provide desired functionality. The model trainer 1060 can be implemented in hardware, firmware, and/or software controlling a general-purpose processor. For example, in some implementations, the model trainer 1060 includes program files stored on a storage device, loaded into a memory and executed by one or more processors. In other implementations, the model trainer 1060 includes one or more sets of computer-executable instructions that are stored in a tangible computer-readable storage medium such as RAM hard disk or optical or magnetic media.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 10B depicts a block diagram of an example computing device 1080 that performs according to example embodiments of the present disclosure. The computing device 1080 can be a user computing device or a server computing device.

The computing device 1080 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 10B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 10C depicts a block diagram of an example computing device 1090 that performs according to example embodiments of the present disclosure. The computing device 1090 can be a user computing device or a server computing device.

The computing device 1090 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 10C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 1090.

The central intelligence layer can communicate with a central device data layer. The central device data layer can be a centralized repository of data for the computing device 1090. As illustrated in FIG. 10C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for performing modeling of dependencies using global self-attention, comprising:
one or more processors; and
one or more non-transitory computer-readable media that collectively store:
a machine-learned model configured to receive a model input and process the model input to generate a model output, wherein the machine-learned model comprises a content attention layer and a positional attention layer configured to operate in parallel with each other, and wherein the machine-learned model is configured to perform operations comprising:
receiving a layer-input comprising input data that comprises a plurality of content values each associated with one or more context positions;
generating, by the content attention layer, one or more output features for each context position based on a global attention operation applied to the content values independent of the context positions;
generating, by the positional attention layer, an attention map for each of the context positions based on one or more of the content values associated with the respective context position and a neighborhood of context positions relative to the respective context position, the positional attention layer comprising at least a column-focused attention sublayer that attends to context positions along a column of each respective context position and a row-focused attention sublayer that attends to context positions along a row of each respective context position; and
determining a layer-output, based at least in part on the one or more output features for each context position generated by the content attention layer and the attention map generated for each context position by the positional attention layer.

2. The computing system of claim 1, wherein the machine-learned model further comprises an input processing layer that generates a plurality of keys, queries, and values derived from the input data.

3. The computing system of claim 1, wherein the global attention operation comprises multiplying the queries, a matrix transpose of the keys with softmax normalization applied to each row, and the values.

4. The computing system of claim 1, wherein the column-focused attention sublayer and row-focused attention sublayer are configured to operate in parallel with each other.

5. The computing system of claim 1, wherein the positional attention layer comprises the column-focused attention sublayer followed by a batch normalization layer that is followed by the row-focused attention sublayer.

6. The computer system of claim 1, wherein the column-focused attention sublayer and the row-focused attention sublayer each are configured to use learned relative positional embeddings for each respective context position.

7. The computing system of claim 1, wherein the positional attention layer comprises the column-focused attention sublayer followed by the batch normalization layer that is followed by the row-focused attention sublayer that is followed by a second batch normalization layer that is followed by a time or depth attention sublayer.

8. The computer system of claim 1, wherein the output of the positional attention layer is determined based at least in part on combining output from each of the attention sublayers.

9. The computer system of claim 1, wherein the machine-learned model has been trained on a set of labeled training data using supervised learning, wherein the supervised learning comprises backpropagating a gradient of a loss function through a plurality of parameters.

10. The computer system of claim 1, wherein the input data comprises at least one of image data, video data, sensor data, audio data, or text data.

11. The computer system of claim 1, wherein the machine-learned model has been trained to perform image recognition, image classification, image captioning, scene segmentation, object detection, action recognition, action localization, image synthesis, semantic segmentation, panoptic segmentation, or natural language processing.

12. The computer system of claim 1, wherein the machine-learned model has been trained on a set of ImageNet training data.

13. The computer system of claim 1, wherein the machine-learned model is used as part of backbone processing in a neural network.

14. The computer system of claim 1, wherein the machine-learned model is used to replace convolutions in a neural network.

15. The computer system of claim 1, wherein a sequence of two or more instances of the machine-learned model are implemented as part of a neural network.

16. The computer system of claim 1, wherein the sequence of the two or more instances of the machine-learned model are arranged consecutively as part of the neural network.

17. The computer system of claim 1, wherein determining the layer-output comprises summing the one or more output features for each context position generated by the content attention layer and the attention map generated for each context position by the positional attention layer.

18. A computer-implemented method for performing modeling of dependencies using global self-attention in machine learning models, the computer-implemented method comprising:
receiving, by a computing system comprising a machine-learned model that comprises a content attention layer and a positional attention layer configured to operate in parallel with each other, a layer-input comprising input data that comprises a plurality of content values each associated with one or more context positions;
generating, by the computing system using the content attention layer, one or more output features for each context position based on a global attention operation applied to the content values independent of the context positions;
generating, by the computing system using the positional attention layer, an attention map for each of the context positions based on one or more of the content values associated with the respective context position and a neighborhood of context positions relative to the respective context position, the positional attention layer comprising at least a column-focused attention sublayer that attends to context positions along a column of each respective context position and a row-focused attention sublayer that attends to context positions along a row of each respective context position; and
determining, by the computing system, a layer-output based at least in part on the one or more output features for each context position generated by the content attention layer and the attention map generated for each context position by the positional attention layer.

19. One or more non-transitory computer-readable media storing instructions that when executed by a computing system cause the computing system to perform operations, the operations comprising:
receiving, by the computing system comprising a machine-learned model that comprises a content attention layer and a positional attention layer configured to operate in parallel with each other, a layer-input comprising input data that comprises a plurality of content values each associated with one or more context positions;
generating, by the computing system using the content attention layer, one or more output features for each context position based on a global attention operation applied to the content values independent of the context positions;
generating, by the computing system using the positional attention layer, an attention map for each of the context positions based on one or more of the content values associated with the respective context position and a neighborhood of context positions relative to the respective context position, the positional attention layer comprising at least a column-focused attention sublayer that attends to context positions along a column of each respective context position and a row-focused attention sublayer that attends to context positions along a row of each respective context position; and
determining, by the computing system, a layer-output based at least in part on the one or more output features for each context position generated by the content attention layer and the attention map generated for each context position by the positional attention layer.
